(19) United States
(12) Patent Application Publication
(10) Pub. No.: US 2020/0064625 A1
(43) Pub. Date: Feb. 27, 2020

(54) METHOD OF FAST SIMULATION OF AN OPTICAL SYSTEM

(71) Applicants: CENTRE NATIONAL DE LA RECHERCHE SCIENTIFIQUE, PARIS (FR); CENTRE NATIONAL D'ETUDES SPATIALES, PARIS CEDEX 01 (FR); UNIVERSITE DE VERSAILLES SAINT-QUENTIN-EN-YVELINES, VERSAILLES CEDEX (FR); SORBONNE UNIVERSITE, Paris (FR)

(72) Inventors: Nicolas ROUANET, MONTIGNY LE BRETONNEUX (FR); Jean-François HOCHEDEZ, PARIS (FR)

(21) Appl. No.: 16/461,358

(22) PCT Filed: Nov. 17, 2017
(86) PCT No.: PCT/EP2017/079586

§ 371 Date: May 15, 2019

(30) Foreign Application Priority Data
Nov. 22, 2016 (FR) 1661363

(51) Int. Cl. G02B 27/00; G06F 17/18; G06F 17/50

(52) U.S. Cl. CPC G02B 27/0012; G06F 2217/16; G06F 17/5009; G06F 17/18

(57) ABSTRACT

A method implemented by computer for simulating an optical system includes the steps consisting in: a) defining a set of light rays or beams at the input (e) of the optical system, each the light ray or beam being represented by a first vector of parameters; and b) calculating, for each the light ray or beam at the input of the optical system, a light ray or beams at the output (s) of the optical system, represented by a second vector of parameters by applying, to each the light ray or beam at the input of the optical system, one and the same nonlinear function, termed the transmission function, representative of the optical system as a whole. A computer program product for the implementation of such a method is also provided.

The invention relates to the field of optical simulation, in particular for assisting the design, optimization, tolerancing and reverse engineering of optical systems. This in particular allows past or future observations of such optical systems to be improved by preventing, limiting or remedying a posteriori certain of their imperfections. The invention may also contribute to the field of image synthesis.

To characterize or design an optical system, it is common to employ a numerical simulation.

The paraxial approximation is the simplest approach allowing an optical system to be modeled. It consists in linearizing Snell's law and in particular applies when the system may be considered to be “perfect”. Under these conditions, a component—or even an optical system—may be modeled by a matrix. Its simulation is therefore simple and economical in computational resources (an analytical solution is even possible). However, the paraxial approximation is satisfactory only if all the rays propagating through the optical system are quite close to the optical axis and not very inclined with respect to the latter.

When the domain of validity of the paraxial approximation is departed from, which is very frequent in practice, aberrations increasingly manifest themselves. To characterize the latter or, more generally, to construct a more accurate representation of the optical system and to exploit said representation for various purposes, it is possible to use a numerical model. A numerical optical model ordinarily takes the form of a dedicated computer program or of a generic software package, such as Zemax (registered trademark) or Code V (registered trademark) inter alia, that it is then necessary to specifically configure. In these programs, the system in question is typically coded in the form of a sequence of optical element layouts, the optical elements themselves being represented by representative data structures. For example, for a catadioptric system, the layouts provide information on the alignment of the mirrors and the data structures specify, inter alia, their radius of curvature. The model of the optical system may then be combined with another model that describes the object, i.e. the source of the rays. These two models may then be used, in association with the laws of optics, to produce simulations capable of being confronted with observables of the (existing, virtual or future) real system or to generate other results, with a view for example to measuring the performance thereof.

The most commonly used numerical simulation technique is ray tracing. In this method, the rays are modeled by numerical objects, and their propagation through the studied optical system is followed by applying thereto a deviation, or any other modification (e.g. change of polarization), calculated by applying the laws of optics, at each interface (for example a dioptric or catadioptric interface) that they encounter.

Alternatively, it is possible to study the propagation of the wavefront. This then gives access to physical optics effects such as for example diffraction or interference effects.

These known prior-art techniques, which go beyond the paraxial approximation, engender computational times that are substantial or even unacceptably long when it is desired to study many configurations or to vary certain degrees of freedom of a given system, with a view to rapid digital prototyping for example.

The article by Thibault Simon et al., “Evolutionary algorithms applied to lens design: Case study and analysis”, Optical Systems Design 2005. (pp. 596209-596209), International Society for Optics and Photonics, is a presentation of a method for global optimization of lens design. Evolutionary algorithms allow, by virtue of manipulation of a population of solutions to a given optimization problem, a solution corresponding to a predefined criterion to be found. To optimize an optical system, a merit function (a cost function, respectively) is initially defined. It increases (decreases, respectively) with the optimality of the operation of the optical system and it allows, in theory, all the configurations leading to the best solution to be determined. Nevertheless, evolutionary algorithms, because of their stochastic nature, have the drawback of not necessarily converging to a solution. They in addition require a considerable amount of computational power.

The document U.S. Pat. No. 5,995,742 describes a method of rapid prototyping lighting systems. This method uses ray tracing and provides a solution to the known problem of the slowness of this technique. The method employs parallelization of the operations with the presentation of a computer architecture that is particularly well optimized for ray-tracing operations. However, recourse to a specific hardware architecture is a major constraint, limiting the applicability of this method.

The article by M. B. Hullin et al. “Polynomial Optics: A Construction Kit for Efficient Ray-Tracing of Lens Systems”, Eurographics Symposium on Rendering 2012, Vol. 31, no. 4, July, 2012, pages 1375-7055 describes a method for simulating an optical system in which analytical solutions of ray-tracing equations are approached via a Taylor series depending on the parameters of the rays. This method decreases the complexity of the computations; however it does not actually allow the study of various configurations of a given optical system to be simplified.

The invention aims to overcome the aforementioned drawbacks of the prior art. More particularly it aims to very substantially decrease the computation time required by an optical simulation not limited to the paraxial approximation. Many applications targeted by the invention (design, optimization, tolerancing, reverse engineering) ordinarily require three elements: a simulation tool (for example a ray tracer), an exploration of one or more criteria (e.g. performance, similarity) depending on the multidimensional configuration of the system, and a computer system (its processor, its architecture, etc.) that executes the two first elements. The relative slowness of conventional ray-tracing techniques leads said slowness to be compensated for via an acceleration of the two other elements. More intelligent algorithms are able to identify the one or more sought after configurations more rapidly by exploring the parameter space more effectively. This however creates drawbacks, such as those mentioned with regard to evolutionary algorithms. The use of specific computer architectures may accelerate the execution of a conventional ray-tracing technique, but creates the drawbacks of a greater complexity and a higher cost. Although it decreases or eliminates the need therefor, the present invention is however liable to benefit, where appropriate, from dedicated computer architectures and/or intelligent algorithms for the exploration of the parameter space.

The invention allows this objective to be achieved via a method that on the one hand may be likened to ray tracing—input rays are specified therein, for example randomly, and the simulation produces their output specifications—but differs therefrom in that it treats the optical system in question in a global fashion, desired output specifications being produced directly from the input specifications of the ray and from the parameters of the system. Thus, the progress of the rays or beams of rays is not calculated all along the sequence of its interactions with matter, this greatly increasing the processing speed.

One specificity of this global approach is the use of a set of non-linear and preferably parametric functions that summarize the behavior of the optical system.

By virtue of the computational rapidity achieved with this approach, the invention makes possible reverse-engineering, optimization and tolerancing activities that were previously otherwise unachievable.

One subject of the invention is a computer-implemented method for simulating an optical system comprising the steps of:

a) defining a set of rays or light beams input (e) into the optical system, each said ray or light beam being represented by a first vector of parameters; and

b) for each said ray or light beam input into the optical system, calculating a ray or light beam output from the optical system, which is represented by a second vector of parameters;

wherein said step b) is implemented by applying, to each said ray or light beam input into the optical system, the same non-linear function, called the transmission function, representative of the optical system in its entirety.

Said transmission function has a parametric form. This means that the transmission function depends on the one hand on its independent variables (defining a ray or beam), but also on other variables, called transmission parameters, which model the behavior of the optical system. In this case, the method may also comprise a prior calibration step, comprising determining a set of parameters of said transmission function by regression on the basis of a simulation of said optical system by a ray-tracing algorithm or on the basis of measurements on said optical system.

Furthermore, at least certain of the parameters of said transmission function may be expressed by a function, called the system function, having as independent variables configuration parameters of said optical system.

Said system function, too, may have a parametric form. This means that the system function depends on the one hand on its independent variables (the vector of the configuration parameters) and on the other hand on other variables, called system parameters.

Together, the configuration vector and system parameters define the action of the optical system on the transmission parameters in question. In this case, the method may also comprise a prior calibration step, comprising: choosing a plurality of configurations of said optical system, each associated with a transmission function having a parametric form; for each said configuration, determining a set of parameters of the transmission function that is associated therewith by regression on the basis of a simulation of said optical system by a ray-tracing algorithm; and determining a set of parameters of said system function by regression on the basis of the parameters thus determined of the transmission functions associated with said configurations of the optical system.

In the latter case, the method may also comprise a qualifying step in which the second vectors of parameters obtained by applying said transmission function to a set of first vectors of parameters are compared with results of simulations of said optical system by said ray-tracing algorithm or on the basis of measurements on said optical system.

Said system function and/or said transmission function may in particular be polynomial or piecewise polynomial.

Said transmission function may be polynomial or piecewise polynomial.

Said first and second vectors of parameters may each comprise position and direction-of-propagation parameters of said light rays.

Said first and second vectors of parameters may each comprise parameters representative of statistical distributions of positions and directions of propagation of rays forming said light beams.

Another subject of the invention is a computer program stored on a nonvolatile computer-readable medium, comprising computer-executable instructions for implementing such a method.

The invention will be better understood and other features and advantages will become more clearly apparent on reading the following nonlimiting description, which is given with reference to the appended figures, in which:

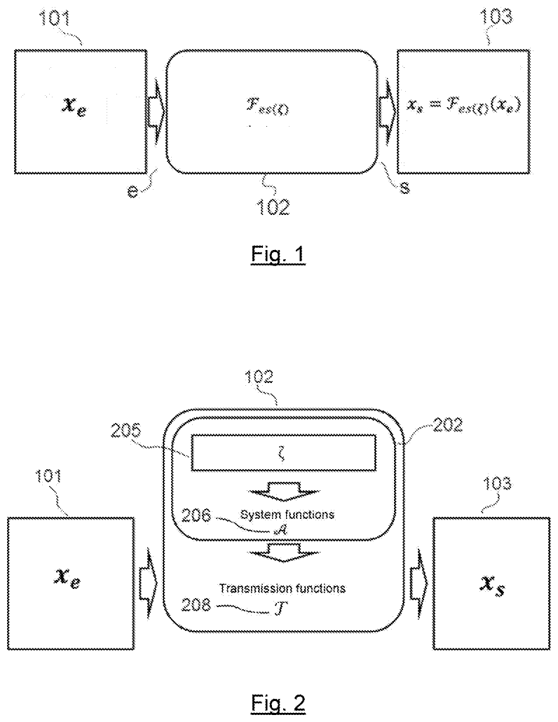

FIG. 1 illustrates the flow chart of the simulation of an optical system according to a first embodiment of the invention;

FIG. 2 illustrates the flow chart of the simulation of an optical system according to a second embodiment of the invention;

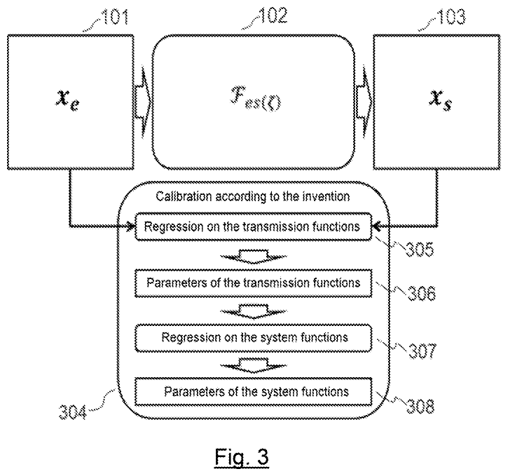

FIG. 3 illustrates the principle of a calibration step of a method according to one embodiment of the invention;

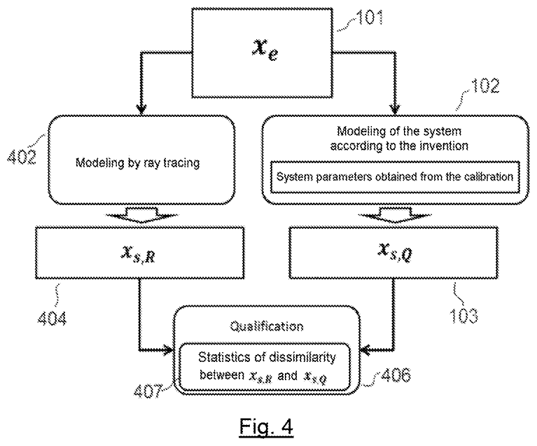

FIG. 4 illustrates the principle of a qualifying step of a method according to one embodiment of the invention, allowing a difference between the output specifications produced by this method and those produced by a reference model to be computed.

FIG. 1 shows the principle of the simulation of the optical system 102 according to one embodiment of the invention.

A first step of this method consists in defining a set of rays or light beams input e into the optical system, in which each ray is represented by a first vector 101 of parameters (“input specifications”). For example, a ray may be represented by a 4-dimensional vector two components of which correspond to the two-dimensional coordinates of the intersection between this ray and an input surface of the system, for example a pupillary plane, and two other components define its propagation direction (“étendue coordinates” or “étendue” is then spoken of). In other variants, additional components may define the wavelength, the phase, the intensity, and/or the polarization of the ray, if these parameters influence the output specifications, for example the path of the beams (case, for example, of a system comprising dispersive elements—such as a spectrometer—or having an optical anisotropy). The presence of phase allows diffraction in a restricted number of planes to be addressed. The input vector may also not represent the specifications of an individual ray (e.g. its coordinates, its wavelength, etc.), but may represent the parameters (averages, standard deviations, inter alia) of (Gaussian, Lambertian, Harvey-Shack, ABg, polynomial, inter alia) statistical distributions of these specifications, thus characterizing a light beam instead of a single ray. This in particular allows scattering effects (situation for which the invention proves to be particularly effective) to be modeled. Specifically, to model scattering effects with a conventional ray-tracing technique requires the propagation of the great many rays generated at each scattering interface, this being very costly in terms of time and computational power. According to the invention, in contrast, it is enough to propagate a single beam.

A second step of the method allows, for each ray (or beam—below only the case of an individual ray will be considered but, unless otherwise specified, all the considerations will also be applicable to beams) input into the optical system, the associated ray output s from the optical system, which is represented by a second vector 103 of parameters (“output specifications”), to be computed. The output vector 103 may have the same components as the input vector 101, or others, typically but not necessarily corresponding to a subset of the input specifications. For example, if it is a question of modeling an imaging system in which the output of the system consists of a matrix-array optical sensor, the vector 103 may be limited to the two spatial coordinates identifying the points at which the output rays encounter the plane of the sensor. In contrast, if a subsystem is modeled, it is generally necessary to calculate all the output specifications so that the latter can be used as input for the following subsystem.

This second step is carried out by applying, to each ray input into the optical system, a non-linear function, called the transmission function, representing the optical system 102 in its entirety. Equation 1 representing the relationship between the specifications of the first vector and those of the second vector is the following:

χₛ= [symbol] (χₑ) (1)

in which χₛ is the vector 103 of the output specifications, χₑ the vector 101 of the input specifications and [symbol] ₑₛ is a transmission function representing transmission from the input e to the output s.

Advantageously, the transmission functions will have a form that is easily usable in a computational code, such as algebraic functions—or optionally transcendental functions. Piecewise defined functions may in particular serve to model discontinuous systems such as mosaics of mirrors. The use of polynomial functions, or piecewise polynomial functions (splines for example) is particularly advantageous. The theory of geometric aberrations suggests that it is opportune to use polynomials of uneven orders, and often stopping at the third order yields satisfactory results. It should be noted that the case where the transmission function is linear (“polynomial” of order 1)—which case does not form part of the invention—corresponds to the paraxial approximation.

Most often, the optical system 102 is not “set”. It may adopt various states, or configurations, each represented by a set (vector) of parameters, which may optionally be variable or unknown. These parameters may represent, for example, the position and/or orientation of various optical elements, the degree of openness of a diaphragm, etc. Thus, instead of one single transmission function [symbol] , it is necessary to use a family of parametric transmission functions [symbol] _{es(ζ)}, and equation (1) then becomes

χₛ= [symbol] _{es(ζ)}(χₑ) (1bis)

In the embodiment in FIG. 2, the optical system 102 of FIG. 1 has been modeled by a doubly nested set of functions and parameters.

Firstly (block 202) functions, generally non-linear functions, called “system functions” 206, express the parameters of the transmission functions (for example, the coefficients of the monomials of a polynomial expression of these functions) as a function of the configuration vector ζ of the optical system. In other words, the configuration vector ζ is the independent variable of the system functions.

Just like the transmission functions, the system functions are preferably algebraic functions, and in particular polynomials of uneven and relatively low order (for example of order 3, 5 or 7). More generally, they may be parametric functions (“system functions”) and may depend on parameters that are what are called “system parameters”. In the case where the system functions have a polynomial form, the system parameters may be the coefficients of the monomials forming these polynomials.

Next (block 202) the transmission functions 206 are applied to the input specifications χₑ in order to deliver the output specifications χₛ.

By way of example, the case where the transmission functions are represented by multivariate polynomials ℑ and where the system functions are also multivariate polynomials [symbol] will be considered. These polynomial approximations are particularly valid when the amplitudes of the variations in the input specifications and/or of the configuration parameters remain limited.

$${x}_{s , d , ζ} = {x}_{s} = {𝒥}_{es ( ζ )}^{[ d ]} ( {x}_{e} ) + {ɛ}_{es , ζ}^{[ d ]} , with \\ {𝒥}_{es ( ζ )}^{[ d ]} ( {x}_{e} ) = {\sum }_{( {\sum }_{j = 1}^{n} {i}_{j} ) \leq d ⋀ {i}_{j} ∈ ℕ} ( {t}_{es ( ζ ) , {( {i}_{j} )}_{1 \leq j \leq n}}^{[ d ]} \times {\prod }_{j = 1}^{n} {x}_{e , j}^{{i}_{j}} ) \qquad ( 2 )$$

in which [symbol] is the transmission polynomial approaching the global transmission function [symbol] _{es(ζ)}, d is the maximum degree permitted for the sum of the exponents of the monomials, the exponents (iⱼ)_{1≤j≤n} are positive or zero,

$${t}_{es ( ζ ) , {( {i}_{j} )}_{1 \leq j \leq n}}^{[ d ]}$$

are the coefficients of the monomials and ε_{es,ζ}^{[d]} is the error of the approximation.

A multivariate polynomial of scalar value and of degree d, having its indeterminate in dimension n, possesses:

$$( \begin{matrix}d + n \\ d\end{matrix} ) = ( \begin{matrix}d + n \\ n\end{matrix} )$$

coefficients. The notation conventional for binomial coefficients is used here.

According to one embodiment, given by way of example, in which the input is étendue, and therefore of 4 dimensions, and the degree d is equal to 3, it is necessary to determine 35 coefficients to calculate each of the 2 coordinates of the point of impact of a ray, i.e. 70 coefficients in total.

Advantageously, the monomials Πⱼ₌₁ⁿ χ_{e,j}ⁱ^{ⱼ} may be calculated beforehand and placed in a matrix Xₑ, equation 2 may then be rewritten in matrix form:

X_{s,d,ζ}=Xₑ^{T}·T_{es,d,ζ}+E_{es,d,ζ} (3)

Equation 3 therefore allows a polynomial estimation of the output specifications the input specifications of which are coded in the vector Xₑ to be calculated. The coefficients

$${t}_{es ( ζ ) , {( {i}_{j} )}_{1 \leq j \leq n}}^{[ d ]}$$

of the transmission polynomials may be calculated using the system functions of the configuration of the optical system 102, which may themselves be expressed by multivariate polynomial functions of the variable ζ.

In particular, it is possible to write:

$${t}_{es ( ζ ) , {( {i}_{j} )}_{1 \leq j \leq n}}^{[ d ]} = {𝒜}_{es , d , ( {i}_{j} )}^{[ d ]} ( ζ ) + {ɛ}_{es , d , ( {i}_{j} )}^{[ r ]} , with \\ {𝒜}_{es , d , ( {i}_{j} )}^{[ r ]} ( ζ ) = {\sum }_{( {\sum }_{q = 1}^{Q} {p}_{q} ) \leq r ⋀ {p}_{q} \geq 0} ( {α}_{es , d , ( {i}_{j} ) , {( {p}_{q} )}_{1 \leq q \leq Q}}^{[ r ]} \times {\prod }_{q = 1}^{Q} {ζ}_{q}^{{p}_{q}} ) \qquad ( 4 )$$

where [symbol] _{es,d,(i}_{ⱼ}₎^{[r]} is the system polynomial approaching the coefficients

$${t}_{es ( ζ ) , {( {i}_{j} )}_{1 \leq j \leq n}}^{[ d ]}$$

of the transmission polynomial [symbol] _{es(ζ)}^{[d]}, r is the maximum degree accepted with respect to representation of the system functions, (p_{q})_{1≤q≤Q} represents the exponents of the monomials

$${α}_{es , d , ( {i}_{j} ) , {( {p}_{q} )}_{1 \leq q \leq Q}}^{[ r ]} ,$$

and ε_{es,d,(i}_{ⱼ}₎^{[r]} is the error in the approximation.

If certain configuration parameters may be set for the problem in question, it is advantageous to not let the corresponding degrees of freedom ζ_{q} vary, with the aim of decreasing the dimensionality of the problem.

As was done for the transmission functions, it is possible to calculate the number of coefficients

$${α}_{es , d , ( {i}_{j} ) , {( {p}_{q} )}_{1 \leq q \leq Q}}^{[ r ]}$$

per system polynomial. The expression of the calculation gives:

$$( \begin{matrix}r + Q \\ r\end{matrix} ) = ( \begin{matrix}r + Q \\ Q\end{matrix} )$$

coefficients.

The monomials Π_{q=1}^{Q} ζ_{q}^{p}^{_{q}} of the system function, just as for the transmission function, may be calculated beforehand and placed in a matrix Z. Equation 4 may then be written in the following matrix form:

T_{es(ζ),d,r}=Z^{T}·A_{es(ζ),d,r}+E_{es(ζ),d,r} (5)

Equation 5 therefore allows a polynomial estimation of the parameters of the transmission functions to be calculated for a configuration coded in the vector Z.

When it is desired to study a plurality of configurations of an optical system for which the paraxial approximation is satisfactory, it is also possible to implement a variant of the method of FIG. 2 in which the transmission functions are linear or affine, optionally piecewise (polynomials of order 1). As in the embodiment described above, the system functions may then be linear or non-linear, and preferably polynomial.

The system coefficients may be estimated, once and for all, during a prior phase called the calibration phase, followed, where appropriate, by a qualification phase. In these two phases, the multidimensional space defined by the étendue and any other specifications of the input ray or beam, multiplied (in the sense of the Cartesian product) by the space of the degrees of freedom of the configuration of the optical system, is sampled relatively parsimoniously and relatively regularly. Specifically, it is difficult to densely sample this space when it is very voluminous, which is normally the case.

The calibration—the whole of which is referenced by the reference 304 in FIG. 3—consists in an inversion (for example a matrix inversion in the case of system and/or transmission functions being of polynomial-type) that tends to minimize the discrepancy between a reference model of the optical system, produced for example using a conventional ray-tracing technique, and the model according to the invention, which must be tailored to the particular case in hand.

To do this, it is for example possible to select ‘C’ different points (ζ_{q})_{1≤q≤Q} in the configuration space then, for each of these C configurations, to select ‘E’ points (rays) in the space of dimension n of the input specifications. It may be effective to select the C configurations pseudo-randomly or quasi-randomly and to select the E input specifications of the rays regularly, typically so as to achieve a tiling of the étendue space.

All these rays are then “propagated” by the ray-tracing software package (such as Zemax or Code V) which will have been initialized beforehand with the studied optical system, which will itself be successively configured with the C aforementioned configurations. Collecting sufficiently precise real observations is an alternative to the calibration by ray tracing described here.

The result of this “conventional” ray tracing may then be exploited by noting that, for a chosen degree d, X_{s,d,ζ} and Xₑ being known in the present calibration circumstance, equation 3 is a linear regression (E equations and

$$( \begin{matrix}d + n \\ d\end{matrix} )$$

unknowns) for each of the selected configurations C.

The solution of this regression, for example using an ordinary least-squares method (reference 305 in FIG. 3), allows the coefficients

$${t}_{es ( ζ ) , {( {i}_{j} )}_{1 \leq j \leq n}}^{[ d ]}$$

of the transmission polynomials to be estimated (306) for the chosen degree d and for each of the C selected configurations ζ. These “transmission” coefficients allow the matrix T_{es(ζ),d,r} to be calculated.

The process may then be reiterated (307) in order to calculate the system coefficients A_{es(ζ),d,r} (308) by noting that equation 5 is another linear regression capable of being solved in various more or less conventional ways.

If the transmission and/or system functions do not have a polynomial form, the corresponding regressions become non-linear, this making the calibration more expensive in computational terms. It will however be noted that the calibration, whether it is simple or complex, is carried out only once or rarely (see discussion with respect to the qualification of the pairs (d, r) below) and upstream. The amount by which the corresponding investment is amortized is therefore proportional to how extensively the model resulting from the present invention and using said calibration is employed.

The qualification—the whole of which is referenced by the reference 406 in FIG. 4—allows the precision of the coefficients obtained during the calibration to be estimated and the degrees d and r of the polynomials to be chosen. In this qualification step, which is optional, rays defined by the input specifications 101 are randomly selected and propagated, on the one hand, (402) by the simulator used in the calibration that modeled the optical system with a conventional ray-tracing algorithm (or by virtue of actual measured observations) and, on the other hand, (102) by a simulator according to the invention. The output specifications 404 produced by the ray-tracing simulator become a reference for the qualification step. The output specifications 103 produced by the simulation according to the invention and the reference specifications 404 may then be compared using a metric such as a distance measuring statistics of dissimilarity 407 between two factors. This approach thus gives rise to an a posteriori statistical validation of the approximations included in the present invention. The qualification may easily be carried out for various pairs (d, r), allowing the best compromise between rapidity/complexity/precision to be found.

The saving in computational time achieved with the invention, by virtue of the global treatment of the optical system, with respect to the conventional ray-tracing approach, for example allows the precision of the simulations to be improved by decreasing the Poisson noise that is associated therewith, or the unitary simulation cost to simply be decreased. It also allows a larger configuration space to be explored than would have been possible before. In this respect, the inventors have applied the method of the invention to remedy a defect in the SODISM (“SOlar Diameter Imager and Surface Mapper”) telescope on board the PICARD space mission of the ONES. This telescope was affected by a variable parasitic reflection due to an unknown optical misalignment. In a few months—instead of several years, which would have been necessary if a prior-art ray-tracing method had been used—the immense parameter space representing the possible misalignments was characterized by the simulator stemming from the present invention. The misalignment responsible for the parasitic reflection was thus determined, and images affected thereby corrected.

This application is given merely by way of illustration, because the invention possesses many others, such as optical design (including optimization, tolerancing, etc.) of imaging or non-imaging systems: lighting and back-lighting devices, radiometers, objectives, microscopes, sights, binoculars and telescopes, etc. It will possibly for example be a question of seeking to minimize the aberrations inherent to non-paraxial optical systems, or to maintain a certain image quality in the presence of movable elements and for various positions of the latter. Said applications also comprise the modeling of natural or technological optical systems, carried out with the aim, for example, of digitally reproducing the real system in order to better understand the observed object and/or the optical system itself, by reconstructing their unknown parameters using an inversion method. The invention also allows a non-continuous system, such as a system comprising mosaics of mirrors, to be simulated, analyzed and designed. The invention may also be applied to the field of computational synthesis of images.

The method of the invention is typically implemented by means of a conventional computer, a server or a distributed computing system, which is suitably programmed. The program allowing this implementation may be written in any high- or low-level language and be stored in a nonvolatile memory, a hard disk for example.

1. A computer-implemented method for simulating an optical system comprising the steps of:
a) defining a set of rays or light beams input (e) into the optical system, each said ray or light beam being represented by a first vector of parameters; and
b) for each said ray or light beam input into the optical system, calculating a ray or light beam output (s) from the optical system, which is represented by a second vector of parameters;
wherein said step b) is implemented by applying, to each said ray or light beam input into the optical system, the same non-linear function, called the transmission function, representative of the optical system in its entirety;
wherein said transmission function has a parametric form, at least certain of the parameters of said transmission function being expressed by a function, called the system function, having as independent variables configuration parameters of said optical system.

2. The method as claimed in claim 1 also comprising a prior calibration step, comprising determining a set of parameters of said transmission function by regression on the basis of a simulation of said optical system by a ray-tracing algorithm or on the basis of measurements on said optical system.

3. The method as claimed in claim 1, wherein said system function has a parametric form.

4. The method as claimed in claim 3 also comprising a prior calibration step, comprising:
choosing a plurality of configurations of said optical system, each associated with a transmission function having a parametric form;
for each said configuration, determining a set of parameters of the transmission function that is associated therewith by regression on the basis of a simulation of said optical system by a ray-tracing algorithm; and
determining a set of parameters of said system function by regression on the basis of the parameters thus determined of the transmission functions associated with said configurations of the optical system.

5. The method as claimed in claim 4 also comprising a qualifying step in which the second vectors of parameters obtained by applying said transmission function to a set of first vectors of parameters are compared with results of simulations of said optical system by said ray-tracing algorithm or on the basis of measurements on said optical system.

6. The method as claimed in claim 1, wherein said system function is polynomial or piecewise polynomial.

7. The method as claimed in claim 1, wherein said transmission function is polynomial or piecewise polynomial.

8. The method as claimed in claim 1, wherein said first and second vectors of parameters each comprise position and direction-of-propagation parameters of said light rays.

9. The method as claimed in claim 1, wherein said first and second vectors of parameters each comprise parameters representative of statistical distributions of positions and directions of propagation of rays forming said light beams.

10. A computer-program product stored on a nonvolatile computer-readable medium, comprising computer-executable instructions for implementing a method as claimed in claim 1.
